(19) United States
(12) Patent Application Publication
(10) Pub. No.: US 2014/0257752 A1
(43) Pub. Date: Sep. 11, 2014

(54) ANALYZING MEASUREMENT SENSORS BASED ON SELF-GENERATED CALIBRATION REPORTS

(71) Applicants: TIMOTHY ANDREW MAST, Plain City, OH (US); KEVIN DALE STARR, Lancaster, OH (US)

(72) Inventors: TIMOTHY ANDREW MAST, Plain City, OH (US); KEVIN DALE STARR, Lancaster, OH (US)

(21) Appl. No.: 13/793,547

(22) Filed: Mar. 11, 2013

(51) Int. Cl. G06F 11/30

(52) U.S. Cl. CPC G06F 11/3065
USPC 702/183

(57) ABSTRACT

Aspects analyze the performance of a plurality of measurement sensors as a function of sensor performance attributes. Different types of sensor performance attribute values are defined for different types of sensors deployed within a manufacturing process infrastructure. The performance attribute values include a nominal value of a sensor data output or a sensor operating voltage signal during operation of the sensor, and an associated range of acceptable values during the operation of the sensor. A drift value defines how far the sensor signal can change over a defined drift time period during the operation of the sensor. Combinations of the defined values are selected for different types of the deployed sensors, and trends determined over time for values of the sensor signals as functions of their different respective selected combinations of values. The sensors are ranked and reported and grouped (as ranked) as a function of the determined trends.

### FIELD OF THE INVENTION

Embodiments of the present invention relate to managing the performance of multiple measurement sensors deployed for on-site diagnostic analysis in response to quality data.

### BACKGROUND

Automated manufacturing systems and process often incorporate self-monitoring or self-diagnosing sensors that monitor attributes of the system or process such as equipment performance, status and quality of product produced, while also monitoring performance attributes of the sensor itself. Software and hardware tools may automate self-diagnostic methods that use the sensor data as inputs, which may make diagnostics more consistent, repeatable, expeditious, and sometimes simpler, when compared to manual methods applied to a given industrial process. However, when large quantities of sensors are deployed a correspondingly large quantity of sensor-generated data may overwhelm both automated and manual diagnostics. Often the generated self-diagnostic sensor data must be filtered by progressively higher thresholds or more restrictive filters to reduce the quantity of the data to a manageable amount. While this may be successful in focusing system management on the most severe problems, for example finding and calling-out data indicative of sensor failures, this is often at the expense of dropping monitoring or consideration of other data that may be useful in recognizing problems within other sensors that have not failed but do warrant attention.

### BRIEF SUMMARY

In one aspect of the present invention, a method for analyzing the performance of a plurality of measurement sensors as a function of sensor performance attributes includes defining different types of sensor performance attribute values for each of different types of sensors that are deployed within a manufacturing process infrastructure. The performance attribute values include a nominal value of a sensor data output or a sensor operating voltage signal during operation of the sensor, and an associated range value that specifies an acceptable range of values of the sensor signal during the operation of the sensor. A drift value defines how far the sensor signal can change over a defined drift time period during the operation of the sensor. A hard lower limit that specifies a threshold below which the sensor signal should not fall during the operation of the sensor, and a hard upper limit that specifies another threshold above which the sensor signal should not rise during the operation of the sensor. Combinations of the defined performance attribute values are selected for each of the different respective types of deployed sensors, wherein the combinations chosen for each sensor include at least one of a combination of the nominal value and the range values, and a combination of the drift value and drift time period values. Trends are determined over time for values of the sensor signals for each of the different deployed sensors as respective functions of their different respective selected combinations of defined values, and the sensors are ranked and reported and grouped (as ranked) as a function of the determined trends in a graphical user interface display.

In another aspect, a system has a processing unit, computer readable memory and a tangible computer-readable storage medium with program instructions, wherein the processing unit, when executing the stored program instructions, defines different types of sensor performance attribute values for each of different types of sensors that are deployed within a manufacturing process infrastructure, in response to inputs from an interactive graphical user interface dashboard presented to a user. The performance attribute values include a nominal value of a sensor data output or a sensor operating voltage signal during operation of the sensor, and an associated range value that specifies an acceptable range of values of the sensor signal during the operation of the sensor. A drift value defines how far the sensor signal can change over a defined drift time period during the operation of the sensor. A hard lower limit that specifies a threshold below which the sensor signal should not fall during the operation of the sensor, and a hard upper limit that specifies another threshold above which the sensor signal should not rise during the operation of the sensor. Combinations of the defined performance attribute values are selected for each of the different respective types of deployed sensors, wherein the combinations chosen for each sensor include at least one of a combination of the nominal value and the range values, and a combination of the drift value and drift time period values. Trends are determined over time for values of the sensor signals for each of the different deployed sensors as respective functions of their different respective selected combinations of defined values, and the sensors are ranked and reported and grouped (as ranked) as a function of the determined trends in a graphical user interface display.

In another aspect, a computer program product for analyzing the performance of a plurality of measurement sensors as a function of sensor performance attributes has a tangible computer-readable storage medium with computer readable program code embodied therewith, the computer readable program code comprising instructions that, when executed by a computer processing unit, cause the computer processing unit to define different types of sensor performance attribute values for each of different types of sensors that are deployed within a manufacturing process infrastructure, in response to inputs from an interactive graphical user interface dashboard presented to a user. The performance attribute values include a nominal value of a sensor data output or a sensor operating voltage signal during operation of the sensor, and an associated range value that specifies an acceptable range of values of the sensor signal during the operation of the sensor. A drift value defines how far the sensor signal can change over a defined drift time period during the operation of the sensor. A hard lower limit that specifies a threshold below which the sensor signal should not fall during the operation of the sensor, and a hard upper limit that specifies another threshold above which the sensor signal should not rise during the operation of the sensor. Combinations of the defined performance attribute values are selected for each of the different respective types of deployed sensors, wherein the combinations chosen for each sensor include at least one of a combination of the nominal value and the range values, and a combination of the drift value and drift time period values. Trends are determined over time for values of the sensor signals for each of the different deployed sensors as respective functions of their different respective selected combinations of defined values, and the sensors are ranked and reported and grouped (as ranked) as a function of the determined trends in a graphical user interface display.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 is a flow chart illustration of a system or method for analyzing the performance of a plurality of measurement sensors as a function of sensor performance attributes according to the present invention.

FIG. 2 is a graphic illustration of a portion of an interactive graphical user interface dashboard according to the present invention.

FIG. 3 is a graphic illustration of a portion of an interactive graphical user interface window according to the present invention.

FIG. 4 is a graphic illustration of a portion of another interactive graphical user interface window according to the present invention.

FIG. 5 is a graphic illustration of a portion of another interactive graphical user interface window according to the present invention.

FIG. 6 is a graphic illustration of a portion of another interactive graphical user interface window according to the present invention.

FIG. 7 is an enlarged view of a portion of the graphical user interface window of FIG. 6.

FIG. 8 is a block diagram illustration of a computerized implementation of an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

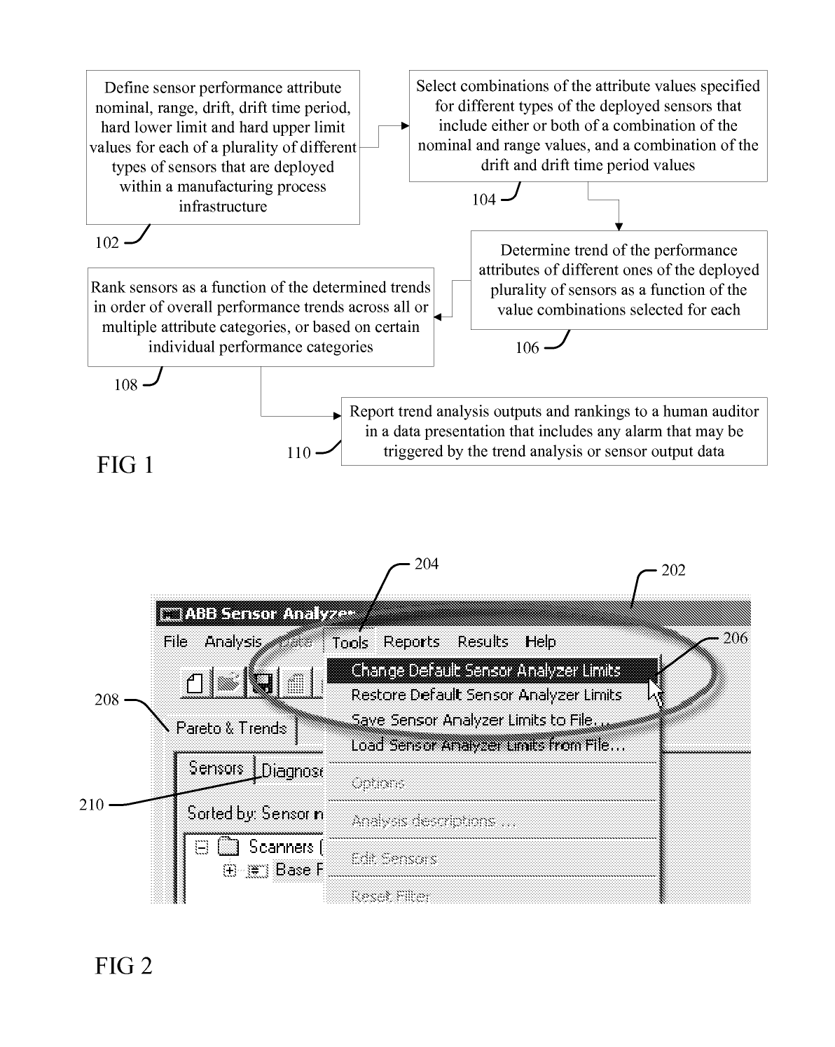

FIG. 1 illustrates a system or method for analyzing the performance of a plurality of measurement sensors as a function of sensor performance attributes according to the present invention. At 102 different types of sensor performance attribute values are defined for each of a plurality of different types of sensors that are deployed within a manufacturing process infrastructure. The sensor performance attribute value are each defined to determine if qualities or attributes of different types of the sensors are within respective acceptable ranges, and may be used to hone rules and calculations to use in determining if a given sensor is operating within limits.

In aspects of the present invention the attribute values include a nominal value that is an ideal value of a performance attribute such as a sensor signal or data output, operating voltage, etc., at which the sensor should be operating, and which is analyzed in conjunction with an associated range value that specifies an acceptable range of values of the performance attribute for sensor operation. The range value defines an acceptable tolerance or “wiggle room” around the nominal value, wherein the acceptable tolerance or range is a range of values from (Nominal value−Range value) through (Nominal Value+Range value).

Attribute value types also include a drift value that defines how far the performance attribute of the sensor can change over a set period of time defined by another, drift time period attribute value, for example over thirty (30) days, five (5) minutes, etc. Drift is a generally slow change in strength or other quality of the sensor output signal over time that is independent of the measured property represented by the signal. Long term drift usually indicates a slow degradation of sensor properties over a long period of time. The drift value is a positive number indicating an allowable amount that the performance attribute may increase, or a negative number indicating an amount that it may decrease, over the drift time period. Drift values are only collected and used for certain sensor types that comprise elements prone to drift, and these fields are unselected or disabled for other sensor types that do not use drift.

The attribute values also include a hard lower limit and a hard upper limit for the performance attribute. The hard lower limit specifies a threshold below which the sensor should not be operating, and the hard upper limit specifies another threshold above which the sensor should not be operating. Violation of either of the hard upper or lower limits will cause an automatic flagging of the sensor's signal to be “out of range,” even if within a specified range of a given specified nominal value. Hard limit values are generally determined by manufacturers, standards, experts or other authoritative entities as fixed and not amenable to editing by an end user.

At 104 aspects of the present invention select combinations of attribute values that are specified for each of the different respective types of deployed sensors, and wherein the combinations chosen for each sensor are selected from a group or set of combinations that includes (i) a combination of the nominal and range values; (ii) a combination of the drift and drift time period values; and (iii) both of the combination of the nominal and range value and the combination of the drift and drift time period values.

At 106 the aspects of the present invention determine a trend of the values of the performance attributes selected for the different sensors deployed within the manufacturing process infrastructure as a function of the value combinations selected for each at 104. At 108 the sensors are ranked as a function of the determined trends. Ranking may be in order of overall performance trends across all or multiple attribute categories, or based on certain individual performance categories.

At 110 the trend analysis outputs and rankings are reported to a human auditor (supervisor, administrator, technician, service tech, manager, machine operator, etc.) in a data presentation, which includes any alarm triggered by the trend analysis or sensor data outputs to flag a technician to take a specific corrective action with respect to one or more of the sensors as a function of the trend analysis. The reporting at 110 may include grouping of related sensors based on identified performance characteristics.

The performance attributes defined for the deployed sensors according to the present invention are selected to indicate reliability, repeatability, and accuracy of outputs from the sensors, which in some aspects may be based on self-generated calibration reports. Monitoring systems generally generate the data for trend analysis, ranking and alarm triggering through sensor self-diagnostics at predetermined intervals, for example every 30 minutes, 50 minutes, one hour, et cetera.

In conventional monitoring systems problems arise when large numbers of deployed sensors are generating self-diagnosing data and alerts. For example, 50 or 60 units within a given set system may generate a flood of information to an administrator, making determination of which of the 50 or 60 units is actually needing attention difficult, and at the very least time consuming. Accordingly, conventional system management of large plurality's of devices and alarm condition threshold events often requires that alarm thresholds are set at extremes of sensor performance, very high or very low, in order to reduce the total number of alarms triggered and reported to a number within the management capabilities of an administrator, something that a manager can comfortably and accurately assess without being overwhelmed. For example, 50 sensor devices generating alarms from specified or properly sensitive threshold settings may generate more alarms then can be administered by a responsible administrator in a given day, workweek, or any other specified work period. However, by setting the thresholds higher or lower in order to reduce the number of alarms to one amenable to adjudication within staffing constraints, certain conditions that should be recognized and corrected are missed. This may result in improper calibration of sensors in certain machines within the system. Furthermore, even if thresholds are set to more sensitive levels at a cost of generating more alarms requiring adjudication resources, true or false or other binary threshold determinations of device failures are not useful in recognizing or diagnosing a device that is trending towards a failure, or is about to failure, since it has not yet triggered attention from an administrator.

In contrast, aspects of the present invention enable large pluralities of sensors to be monitored in an efficient manner via periodic trending analysis methods that recognizes deterioration of sensor performances that are indicative of impending failure before it happens, before the performance of a given sensor deteriorates past a given threshold limit. Aspects may thereby analyze large quantities of sensor performance outputs reported by self-diagnostics on a continual basis, wherein the sensor output data associated with 40 man-hours of alarm adjudication and analysis under conventional binary threshold decision data may instead be completed almost instantaneously by automated trend analysis aspects of the present invention. Performing trend analysis on a regular basis creates trend data which enable aspects of the present invention to spot imminent sensor failures before they result in catastrophic failures, preventing problems before they arise. Displaying the results in ranked orders further enables an administrator to prioritize actions on the sensors with most highly-ranked attributes of concern.

Aspects facilitate programmatic evaluation for the sensor analyzer diagnoses using Key Performance Indicator (KPI) methodology and views, store values used in said KPI calculations. FIG. 2 illustrates a view of a portion of an interactive dashboard 202 that is presented to the human auditor or another user in a graphical user interface (GUI) that enables the user to set or edit default and other values and sensor-specific analyzer limits for the sensor performance attributes at 102 and 104 of FIG. 1. In the present example the user accesses a default value setting functionality by selecting via a cursor routine the “Change Default Sensor Analyzer Limits” choice 206 from the Tools menu 204 while a “Pareto and Trends” tab 208 is active in the dashboard 202.

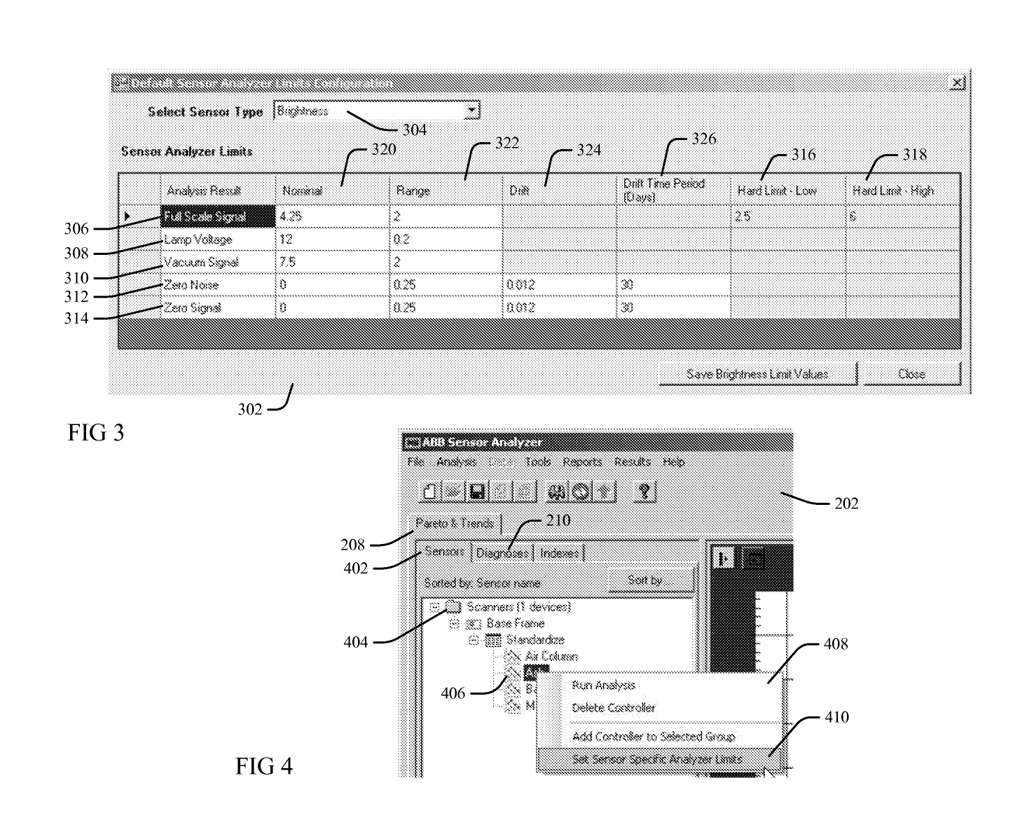

FIG. 3 illustrates a “Default Sensor Analyzer Limits Configuration” window 302 that opens in response to cursor routine selection of the “Change Default Sensor Analyzer Limits” choice 206 of FIG. 2. A pull-down field 304 allows the user to select a sensor by type, which in this example is a Brightness sensor type. A tabular configuration displays the values set for each of five different analysis result attributes of the selected brightness type of sensor: a Full Scale Signal 306, Lamp Voltage 308, Vacuum Signal 310, Zero Noise 312 and Zero Signal 314.

Fields of the tabular presentation 302 that are grey indicate that the values within said fields are not active for revision or entry of values by the user. These fields are either not applicable to respective one of the five different analysis result attributes, or they are applicable but not revisable by user input. In the present example the Hard-Limit Low fields 316 and the Hard-Limit High fields 318 have non-revisable values of “2.5” and “6”, respectively, for the Full Scale Signal attribute 306 that are specified by a manufacturer, supervisor, administrator, etc., and may not be revised by the present user. The remainders of their fields are grey and black, indicating that they are not-applicable to the other four analysis result attributes 308, 310, 312 and 314.

In contrast, all of the Nominal 320 and Range 322 fields are active fields with values populated within white backgrounds for each of the five analysis result attributes 306, 308, 310, 312 and 314, and thus each of these field values respective values may be set or revised by the user. The Drift 324 and Drift Time Period 326 fields are active fields with values populated within white backgrounds that be set or revised by the user for the Zero Noise 312 and Zero Signal 314, and the other fields thus each of these field values respective values; their other fields (Full Scale Signal 306, Lamp Voltage 308, Vacuum Signal 310) are each grey and thus not active or applicable to these attributes.

In this example the Zero Noise attribute 312 has a Drift 324 value of “0.012” and a Drift Time Period 324 value of “30” days, which provides that sensor output data cannot vary by more than this value over 30 days of data, else this indicates that the sensor itself is starting to fail, that it's sensitivity is getting weaker. Thus, even if the observed voltage the Zero Noise attribute 312 does not exceed the specified nominal voltage value 320 of “0” by more than the specified Range value 322 of “0.25”, it is still within it's nominal and range values, the drift analysis may trigger an alert or a high ranking value for reporting a possible service incident to the human auditor at 110 of FIG. 1.

Aspects thus add severity into binary determinations of sensor performance, a quality of severity of change in performance, wherein corrective actions may then be taken based on a priority of severity, how bad or how close such performance is to a threshold of concern. This is not just a conversion of Boolean decisions into a sorted list, but rather a conversion of Boolean decisions into a severity measure metrics as a function of data history, which creates a new measure of performance of sensor devices that is not captured by Boolean determinations.

In some aspects of the present invention the user may also set limits specific to sensor data imported into the application. For example, as shown in FIG. 4, while the “Sensors” tab 402 of the “Pareto & Trends” tab 208 of the an interactive dashboard 202 is active or selected, the user may expand scanner items 404 and drill down to the individual sensors 406. Right-clicking on a specific sensor 406 will open a context menu 408 that includes as an option to “Set Sensor Specific Analyzer Limits” 410.

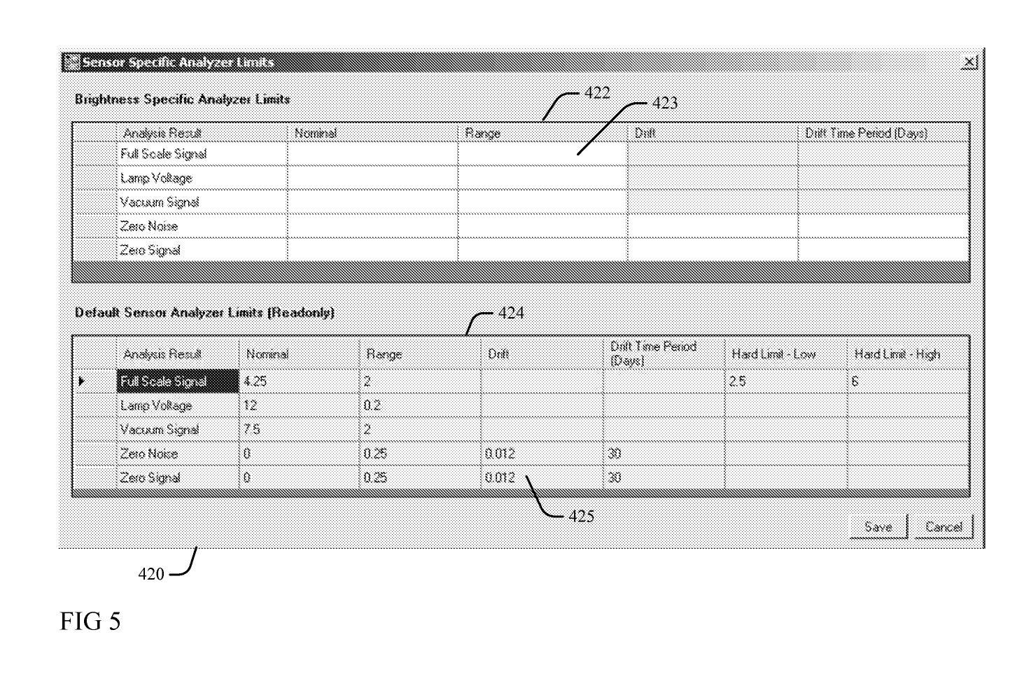

Clicking on or otherwise selecting the “Set Sensor Specific Analyzer Limits” option 410 cause a display of the “Sensor Specific Analyzer Limits” screen 420 illustrated in FIG. 5 that is specific to the selected sensor. In this screen a user may setup limits for the specific sensor instance which will override the values established in the Default Sensor Analyzer Limits Configuration screen 302 of FIG. 3. The window 420 includes a top grid 422 containing the specific sensor's limits, and a bottom grid 424 that provides a read-only version of the Default Sensor Analyzer Limits shown in 302. The user can override the general/default settings by entering values in the active (white) fields 423 of the top grid 422, and if a value is entered this value will be used for the sensor. If a field 423 is left blank, then the sensor analyzer application calculations use the values as shown populated in the respective fields 425 in the default settings of screen 424.

Aspects of the present invention perform sensor analyzer diagnosis processes as a function of KPI's. In one example implemented in a paper and pulp processing infrastructure the sensor analyzer introduces programmatic diagnosis calculations based on limit numbers from sensor specialists and other user inputs for the following sensor types: Ash, Brightness, Caliper, Color, Fiber Orientation Angle, Fiber Orientation Ratio, Formation, Gloss, High-Performance Infrared (HPIR) Moisture, Infrared Coat Weight (IR CW) Clay and Latex, Microwave Moisture, Moisture IR, Opacity, Optical Caliper, Temperature and Weight.

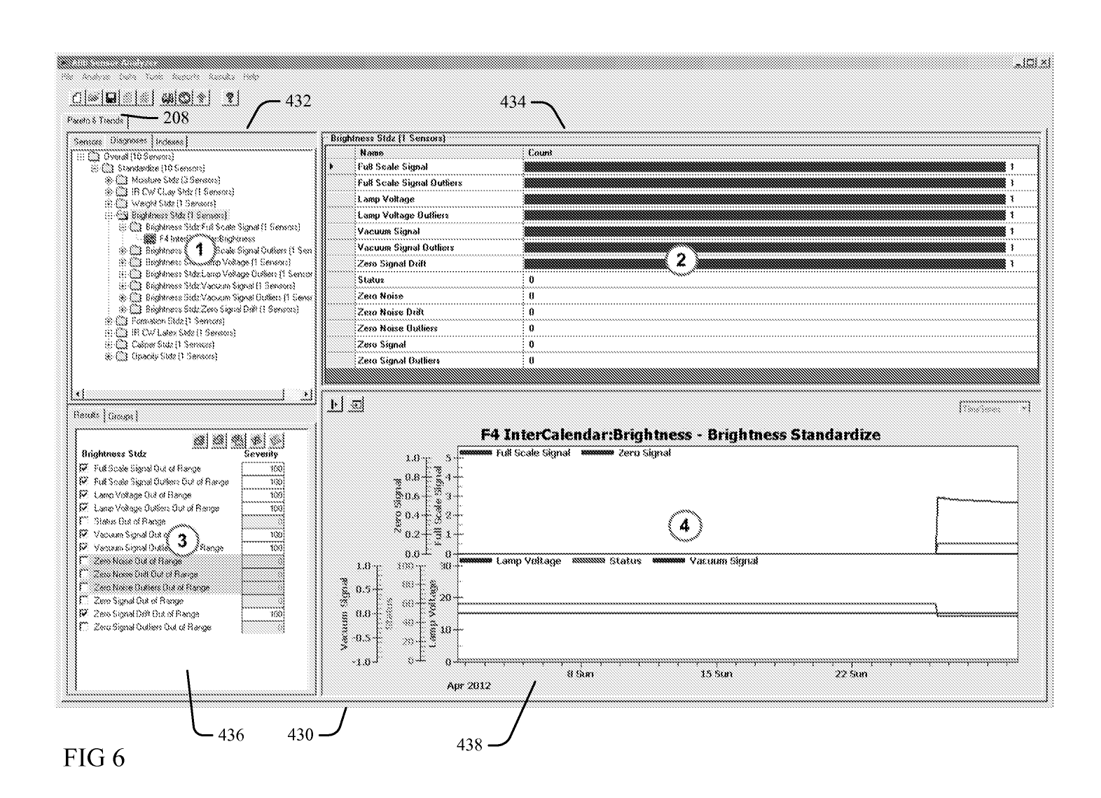

Diagnosis KPI's are also determined by aspects of the present invention. After the user loads the sensor data and runs an analysis, selecting the “Diagnosis” tab 210 of the interactive dashboard 202 (shown in FIG. 2 and FIG. 4) will cause the display of a Diagnosis (KPI) window 430 of FIG. 6 within the Pareto & Trends tab 208 that which has four sections: (1) Navigation Tree 432, (2) KPI Graph 434, (3) KPI Results for a specific, selected sensor 436, and (4) Data Trend chart 438 for the selected sensor.

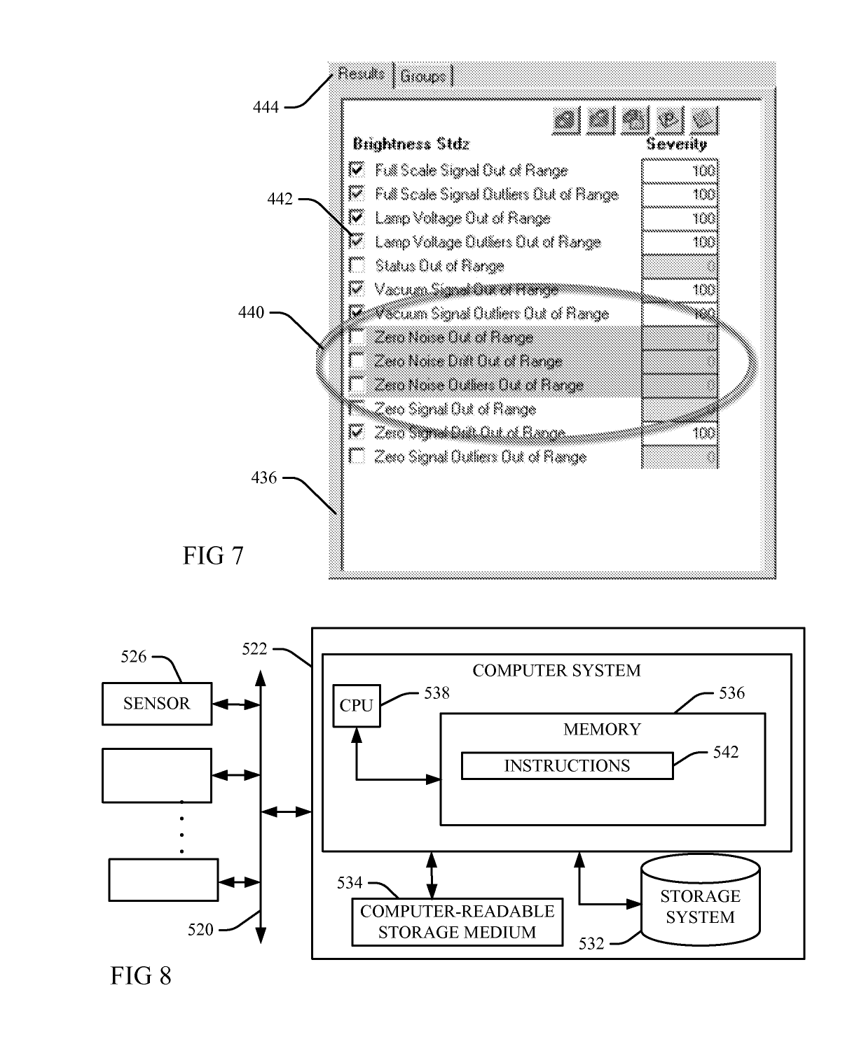

FIG. 7 is an enlarged view of the (3) KPI Results for the specific, selected sensor 436, which in this case is the Brightness sensor. If there is not enough information for a particular sensor's signal to be programmatically evaluated (i.e. there is insufficient sensor limit information, or if the imported sensor data does not include data for the signal), then the corresponding signal result row will be shaded gray, as seen in group of signal results 440 for Zero Noise Out of Range, Zero Drift Out of Range and Zero Noise Outliers Out of Range. The user can check/uncheck the corresponding check boxes 442 and enter severity values on this “Results” tab view 444 of the “Pareto & Trends” view 208. Thus, even if the application was not able to programmatically evaluate the sensor signal, users may inspect the data themselves and set the result data as appropriate.

Aspects of the invention may perform a variety of types of signal analysis for a given sensor signal. One type of signal analysis is a “Status Analysis” of status data provided by a sensor. In one example if the data for a particular sensor has any status value greater than 1, then it is considered to be a “bad status” and the sensor will be flagged as having a problem. The severity value for a “Status Out of Range” result in some examples is a count of “bad status” values for that sensor.

Another type of signal analysis is average value analysis, which is performed based on the mean (average) value of the sensor signal data. The acceptable range of values is calculated based on the entered sensor limits. If the average value of the sensor signal does not fall within the acceptable range, then the signal is flagged as having a problem. Average value analysis results may be labeled as “[Signal Name] Out of Range”.

Outlier values analysis is also performed, generally in the same way that the average value analysis is performed, except that it is performed on both the minimum and maximum sensor signal values. Outlier values analysis evaluates if any of the data values provided for the sensor single were out of range, not just an averaged-out value. Outlier Values Analysis results may be labeled as “[Signal Name] Outliers Out of Range”.

Drift Analysis is also performed. Some sensors have signals where there is an appropriate amount of movement that the signal values may “drift” over a defined time period. If the data values for the signal drift more than the indicated drift limit, then the signal will be flagged as having a problem. Drift analysis results may be labeled as “[Signal Name] Drift Out of Range”.

Thus, aspects of the present invention define a performance methodology that defines a ranking for the performance of large numbers of sensors (for example, 50 or more) simultaneously. The embodiments analyzes the reliability (standardize), repeatability (check sample), and accuracy (correlation) of measurement sensors based on self-generated calibration reports, such as standardize, check sample reports, correlate sample reports and others. Aspects allow large sets of sensors to be data mined to isolate those that require corrective action. Standardized viewing and analysis enables more user time to be allocated toward value added activities. The combination of fully automatic and manual detection techniques allow benefits from both methods to be realized. Ranking is based on overall performance as well as individual performance categories, and may also group related sensors based on identified performance characteristics. While similar sensors require similar types of data, aspects are responsive to the facts that data sets for different types of sensors can be unique.

With regard to a paper machine process, quality control system must assure that a variety of products are satisfactorily produced, including fine writing paper, paper board, tissue, newsprint, and packaging. The quality control system must measure the properties or each of these types of paper product, as well as others, and control processes for the highest quality paper and the best utilization of raw materials.

A common subsystem in paper process quality control systems is a scanning platform that has multiple sensors that scan the sheet to measure paper properties. These paper property measurements included the Basis Weight, Moisture, Caliper, Ash, Gloss, Color, Formation, Coat Weight and Opacity of the paper. The measurement must be on target to ensure the papermaker can produce the desired paper type. The measurement must be accurate and sensor calibrated. If a measurement is out of specification or off-target, but it is known that the sensor is performing with accuracy and precision, then the quality control system can make a control correction to bring the measurement within the desire value. Aspects of the present invention help ensure that the sensors are performing with accuracy and precision.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium excludes transitory, propagation or carrier wave signals or subject matter and includes an electronic, magnetic, optical, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that does not propagate but can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Referring now to FIG. 8, an exemplary computerized implementation of an embodiment of the present invention includes a computer system or other programmable device 522 in communication with a plurality of sensors 526. Instructions 542 reside within computer readable code in a computer readable memory 536, or in a computer readable storage system 532, or other tangible computer readable storage medium 534 that is accessed through a computer network infrastructure 520 by a processing unit (CPU) 538. Thus, the instructions, when implemented by the processing unit (CPU) 538, cause the processing unit (CPU) 538 to analyze the performance of a plurality of measurement sensors as a function of sensor performance attribute as described above with respect to FIGS. 1-7.

Embodiments of the present invention may also perform process steps of the invention on a subscription, advertising, and/or fee basis. That is, a service provider could offer to integrate computer-readable program code into the computer system 522 to enable the computer system 522 to analyze the performance of a plurality of measurement sensors 526 as a function of sensor performance attribute as described above with respect to FIGS. 1-8. The service provider can create, maintain, and support, etc., a computer infrastructure such as the computer system 522, network environment 520, or parts thereof, that perform the process steps of the invention for one or more customers. In return, the service provider can receive payment from the customer(s) under a subscription and/or fee agreement. Services may comprise one or more of: (1) installing program code on a computing device, such as the computer device 522, from a tangible computer-readable medium device 534 or 532; (2) adding one or more computing devices to a computer infrastructure; and (3) incorporating and/or modifying one or more existing systems of the computer infrastructure to enable the computer infrastructure to perform the process steps of the invention.

The terminology used herein is for describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof. Certain examples and elements described in the present specification, including in the claims and as illustrated in the Figures, may be distinguished or otherwise identified from others by unique adjectives (e.g., a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated herein.

What is claimed is:

1. A method for analyzing the performance of a plurality of measurement sensors as a function of sensor performance attributes, the method comprising:
defining a plurality of different types of sensor performance attribute values for each of a plurality of different types of sensors that are deployed within a manufacturing process infrastructure, wherein the performance attribute values comprise:
a nominal value of a sensor signal during operation of the sensor, wherein the sensor signal is a sensor data output or a sensor operating voltage;
a range value that is associated with the nominal value and specifies an acceptable range of values of the sensor signal during the operation of the sensor;
a drift value that defines how far the sensor signal can change over a defined drift time period during the operation of the sensor;
a hard lower limit that specifies a threshold below which the sensor signal should not fall during the operation of the sensor; and
a hard upper limit that specifies another threshold above which the sensor signal should not rise during the operation of the sensor;
selecting combinations of performance attribute values for each of the different respective types of deployed sensors, and wherein the combinations chosen for each sensor comprise at least one of a combination of the nominal value and the range values, and a combination of the drift value and drift time period values;
determining a trend of values of the sensor signal over time for each of the different sensors deployed within the manufacturing process infrastructure as respective functions of their different respective selected at least one combination of the combination of the nominal value and the range values, and the combination of the drift value and drift time period values;
ranking the sensors as a function of the determined trends; and
reporting the determined trends of values of the sensor signal over time for each of the different sensors grouped in a graphical user interface display as a function of the sensor ranking.

2. The method of claim 1, wherein the reporting comprises an alarm triggered by the trend value determined for a first one of the sensors failing to meet a condition of the at least one combination of the nominal value and the range values, and the combination of the drift value and drift time period values that is selected for the first failing sensor.

3. The method of claim 2, wherein the reporting comprises groupings of related sensors based on identified performance characteristics.

4. The method of claim 2, further comprising:
presenting an interactive graphical user interface dashboard to a user that enables the user to edit values set for the nominal value, the range value, the drift value and the defined drift time period for selected ones of the sensors.

5. The method of claim 2, further comprising:
triggering the reported alarm as a function of the determined trend value failing to meet the condition of the at least one combination of the nominal value and the range values, and the combination of the drift value and drift time period values that is selected for the first failing sensor, but wherein the value of the sensor signal during the operation of the first sensor over a timespan of the determined trend does not fall below the hard lower limit set for the first sensor and does not rise above the hard upper limit set for the first sensor.

6. The method of claim 5, wherein the manufacturing process is a paper manufacturing process; and
wherein the plurality of different types of sensor comprises ash, brightness, caliper, color, fiber orientation angle, fiber orientation ratio, formation, gloss, high-performance infrared moisture, infrared coat weight clay, infrared coat weight latex, microwave moisture, moisture infrared, opacity, optical caliper, temperature and weight sensor types.

7. The method of claim 5, further comprising:
integrating computer-readable program code into a computer system comprising a processing unit, a computer readable memory and a computer readable tangible storage medium, wherein the computer readable program code is embodied on the computer readable tangible storage medium and comprises instructions that, when executed by the processing unit via the computer readable memory, cause the processing unit to:
define, in response to inputs from the interactive graphical user interface dashboard presented to the user, the plurality of different types of sensor performance attribute values for each of the different types of sensors deployed within the manufacturing process infrastructure;
select the combinations performance attribute values for each of the different respective types of deployed sensors;
determine the trend of values of the sensor signal over time for each of the different sensors deployed within the manufacturing process infrastructure as respective functions of their different respective selected at least one combination of the combination of the nominal value and the range values, and the combination of the drift value and drift time period values;
rank the sensors as the function of the determined trends; and
report the determined trends of values of the sensor signal over time for each of the different sensors grouped in the graphical user interface display as a function of the sensor ranking.

8. A system, comprising:
a processing unit in communication with a computer readable memory and a tangible computer-readable storage medium;
wherein the processing unit, when executing program instructions stored on the tangible computer-readable storage medium via the computer readable memory:
defines, in response to inputs from an interactive graphical user interface dashboard presented to a user, a plurality of different types of sensor performance attribute values for each of a plurality of different types of sensors that are deployed within a manufacturing process infrastructure, wherein the performance attribute values comprise:
a nominal value of a sensor signal during operation of the sensor, wherein the sensor signal is a sensor data output or a sensor operating voltage;
a range value that is associated with the nominal value and specifies an acceptable range of values of the sensor signal during the operation of the sensor;
a drift value that defines how far the sensor signal can change over a defined drift time period during the operation of the sensor;
a hard lower limit that specifies a threshold below which the sensor signal should not fall during the operation of the sensor; and
a hard upper limit that specifies another threshold above which the sensor signal should not rise during the operation of the sensor;
selects combinations of performance attribute values for each of the different respective types of deployed sensors, and wherein the combinations chosen for each sensor comprise at least one of a combination of the nominal value and the range values, and a combination of the drift value and drift time period values;
determines a trend of values of the sensor signal over time for each of the different sensors deployed within the manufacturing process infrastructure as respective functions of their different respective selected at least one combination of the combination of the nominal value and the range values, and the combination of the drift value and drift time period values;
ranks the sensors as a function of the determined trends; and
reports the determined trends of values of the sensor signal over time for each of the different sensors grouped in a graphical user interface display as a function of the sensor ranking.

9. The system of claim 8, wherein the processing unit, when executing the program instructions stored on the computer-readable storage medium via the computer readable memory, further triggers and reports an alarm in response to the trend value determined for a first one of the sensors failing to meet a condition of the at least one combination of the nominal value and the range values, and the combination of the drift value and drift time period values that is selected for the first sensor, and to the value of the sensor signal during the operation of the first sensor over a timespan of the determined trend not falling below the hard lower limit set for the first sensor and not rising above the hard upper limit set for the first sensor.

10. The system of claim 9, wherein the processing unit, when executing the program instructions stored on the computer-readable storage medium via the computer readable memory, further reports the determined trends of values of the sensor signal over time for each of the different sensors grouped in the graphical user interface display as the function of the sensor ranking by grouping related sensors based on identified performance characteristics.

11. The system of claim 10, wherein the processing unit, when executing the program instructions stored on the computer-readable storage medium via the computer readable memory, further presents the interactive graphical user interface dashboard to the user to enable the user to edit values set for the nominal value, the range value, the drift value and the defined drift time period for selected ones of the sensors.

12. The system of claim 11, wherein the manufacturing process is a paper manufacturing process; and
wherein the plurality of different types of sensor comprises ash, brightness, caliper, color, fiber orientation angle, fiber orientation ratio, formation, gloss, high-performance infrared moisture, infrared coat weight clay, infrared coat weight latex, microwave moisture, moisture infrared, opacity, optical caliper, temperature and weight sensor types.

13. A computer program product for analyzing the performance of a plurality of measurement sensors as a function of sensor performance attributes, the computer program product comprising:
a computer readable tangible storage medium having computer readable program code embodied therewith, the computer readable program code comprising instructions that, when executed by a computer processing unit, cause the computer processing unit to:
define, in response to inputs from an interactive graphical user interface dashboard presented to a user, a plurality of different types of sensor performance attribute values for each of a plurality of different types of sensors that are deployed within a manufacturing process infrastructure, wherein the performance attribute values comprise:
a nominal value of a sensor signal during operation of the sensor, wherein the sensor signal is a sensor data output or a sensor operating voltage;
a range value that is associated with the nominal value and specifies an acceptable range of values of the sensor signal during the operation of the sensor;
a drift value that defines how far the sensor signal can change over a defined drift time period during the operation of the sensor;
a hard lower limit that specifies a threshold below which the sensor signal should not fall during the operation of the sensor; and
a hard upper limit that specifies another threshold above which the sensor signal should not rise during the operation of the sensor;
select combinations of performance attribute values for each of the different respective types of deployed sensors, and wherein the combinations chosen for each sensor comprise at least one of a combination of the nominal value and the range values, and a combination of the drift value and drift time period values;
determine a trend of values of the sensor signal over time for each of the different sensors deployed within the manufacturing process infrastructure as respective functions of their different respective selected at least one combination of the combination of the nominal value and the range values, and the combination of the drift value and drift time period values;
rank the sensors as a function of the determined trends; and
report the determined trends of values of the sensor signal over time for each of the different sensors grouped in a graphical user interface display as a function of the sensor ranking.

14. The computer program product of claim 13, wherein the computer readable program code instructions, when executed by the computer processing unit, further cause the computer processing unit to trigger and report an alarm in response to the trend value determined for a first one of the sensors failing to meet a condition of the at least one combination of the nominal value and the range values, and the combination of the drift value and drift time period values that is selected for the first sensor, and to the value of the sensor signal during the operation of the first sensor over a timespan of the determined trend not falling below the hard lower limit set for the first sensor and not rising above the hard upper limit set for the first sensor.

15. The computer program product of claim 14, wherein the computer readable program code instructions, when executed by the computer processing unit, further cause the computer processing unit to report the determined trends of values of the sensor signal over time for each of the different sensors grouped in the graphical user interface display as the function of the sensor ranking by grouping related sensors based on identified performance characteristics.

16. The computer program product of claim 14, wherein the computer readable program code instructions, when executed by the computer processing unit, further cause the computer processing unit to present the interactive graphical user interface dashboard to the user to enable the user to edit values set for the nominal value, the range value, the drift value and the defined drift time period for selected ones of the sensors.

17. The computer program product of claim 16, wherein the manufacturing process is a paper manufacturing process; and
wherein the plurality of different types of sensor comprises ash, brightness, caliper, color, fiber orientation angle, fiber orientation ratio, formation, gloss, high-performance infrared moisture, infrared coat weight clay, infrared coat weight latex, microwave moisture, moisture infrared, opacity, optical caliper, temperature and weight sensor types.
